(19) United States
(12) Patent Application Publication
(10) Pub. No.: US 2024/0176980 A1
(43) Pub. Date: May 30, 2024

(54) SYSTEM AND METHOD FOR QUESTION ANSWERING CAPABLE OF INFERRING MULTIPLE CORRECT ANSWERS

(71) Applicant: Electronics and Telecommunications Research Institute, Daejeon (KR)

(72) Inventors: Hyung Jik LEE, Daejeon (KR); Kyungman BAE, Daejeon (KR); Minho KIM, Daejeon (KR); HyunKi KIM, Daejeon (KR); Jihyeon ROH, Daejeon (KR); Jihee RYU, Daejeon (KR); YONGJIN BAE, Daejeon (KR); Myung Gil Jang, Daejeon (KR)

(73) Assignee: Electronics and Telecommunications Research Institute, Daejeon (KR)

(21) Appl. No.: 18/452,357

(22) Filed: Aug. 18, 2023

(30) Foreign Application Priority Data
Nov. 28, 2022 (KR) 10-2022-0161689

(51) Int. Cl. G06N 3/006

(52) U.S. Cl. CPC G06N 3/006

(57) ABSTRACT

The present disclosure relates to a question answering system and method capable of inferring multiple correct answers. The question answering system capable of inferring multiple correct answers according to the present disclosure includes an input interface device configured to receive a query, a memory for storing a program that analyzes the query and searches for a paragraph with a high probability of including a correct answer through a document search, and a processor for executing the program, wherein the processor extracts a correct answer using a result of the searching for a paragraph with a high probability of including a correct answer, determines whether the extracted correct answer corresponds to multiple correct answers, and provides a correct answer extraction result.

### CROSS-REFERENCE TO RELATED APPLICATION

This application claims priority to and the benefit of Korean Patent Application No. 10-2022-0161689, Nov. 28, 2022, the disclosure of which is incorporated herein by reference in its entirety.

### BACKGROUND

### 1. Technical Field

The present disclosure relates to a question answering system and method capable of inferring multiple correct answers.

### 2. Related Art

A multi-correct answer question refers to a question to which there can be several correct answers at the same time, rather than a case where there can be only one correct answer to a question, and actually, there are cases where there are several correct answers that satisfy the question, or there are cases where a single correct answer cannot be specified due to controversy. According to the related art, it is possible to infer the case where there is no correct answer and the case where there is the same correct answer in different documents, but the ability to infer different correct answers as the correct answer at the same time is insufficient.

### SUMMARY

The present disclosure has been proposed to address the above-described drawbacks, and the purpose of the present disclosure is to provide a question answering system and method capable of inferring and presenting multiple correct answers by additionally verifying whether the paragraph is in support/opposition of/to the correct answer when there is a possibility of multiple correct answers.

The question answering system capable of inferring multiple correct answers according to the present disclosure includes an input interface device configured to receive a query, a memory for storing a program that analyzes the query and searches for a paragraph with a high probability of including a correct answer through a document search, and a processor for executing the program, wherein the processor extracts a correct answer using a result of the searching for a paragraph with a high probability of including a correct answer, determines whether the extracted correct answer corresponds to multiple correct answers, and provides a correct answer extraction result.

The processor performs a symbolic search and a deep learning search, and ranks the searched paragraphs by linearly combining a symbolic-based paragraph search score and a deep learning-based paragraph search score.

The processor re-ranks the ranked paragraphs using a deep learning re-ranking model.

The processor determines whether there are multiple correct answers using the linear combination of re-ranking probability and machine reading probability.

The processor uses a multi-task model capable of inferring correct answer, answering for a case where there is no correct answer, and answering in a Yes/No form.

The processor verifies whether the searched paragraph is a paragraph supporting the correct answer.

When determining that the searched paragraph does not support the correct answer, the processor excludes the corresponding correct answer and paragraph.

The question answering method capable of inferring multiple correct answers according to the present disclosure includes (a) analyzing an input query, (b) performing a document search through a symbolic-based paragraph search and a deep learning-based paragraph search, (c) ranking and re-ranking the searched paragraphs, (d) extracting correct answers from the searched paragraph and determining whether there are multiple correct answers, and (e) presenting the extracted correct answer to a user.

The step (a) includes performing a linguistic analysis including a morphological analysis, a named entity recognition, and a syntactic analysis.

The step (c) includes ranking the searched paragraphs by linearly combining a symbolic-based paragraph search score and a deep learning-based paragraph search score.

The step (c) includes performing the re-ranking using a deep learning re-ranking model trained with question-(correct answer paragraph, incorrect answer paragraph).

The step (d) includes linearly combining re-ranking probability and machine reading comprehension probability, and determining that there are multiple correct answers when the result of the linear combination exceeds a threshold value.

The step (e) includes determining whether the paragraph from which the correct answer is extracted through machine reading comprehension is a paragraph supporting the correct answer, and when determining that the searched paragraph does not support the correct answer, excluding the corresponding correct answer and paragraph.

The step (e) includes, when it is determined that the searched paragraph supports the correct answer, regarding that there are valid multiple correct answers and merging correct answer support paragraphs for a same correct answer.

According to the present disclosure, it is possible to solve the multi-answer question that can frequently occur in open domain questions and answers. According to the present disclosure, it is possible to solve the multiple correct answer question by determining whether there are multiple correct answers, and once again determining whether the paragraph supports the correct answer. The effects of the present disclosure are not limited to those mentioned above, and other unmentioned effects will be clearly understood by those skilled in the art from the description below.

### BRIEF DESCRIPTION OF THE DRAWINGS

FIG. 1 shows a question answering system capable of inferring multiple correct answers according to an embodiment of the present disclosure.

FIG. 2 shows a question answering method capable of inferring multiple correct answers according to an embodiment of the present disclosure.

FIG. 3 is a block diagram illustrating a computer system for implementing the method according to the embodiment of the present invention.

### DETAILED DESCRIPTION

Above-described objects and other objects, and advantages and characteristics of the disclosure, and methods of achieving them will become apparent with reference to the embodiments described below in detail in conjunction with the accompanying drawings.

However, the present disclosure is not limited to the embodiments disclosed below, but can be implemented in a variety of different forms, and the following embodiments are merely provided to easily inform those skilled in the art of the purpose of configuration and effects of the disclosure, and the scope of the patent right of the present disclosure is defined by the description of the claims.

Meanwhile, as used herein, the terms are for the purpose of describing the embodiments, and are not intended to limit the present disclosure. In this specification, terms in the singular form also relate to the plural form unless specifically stated otherwise in the context. As used herein, the term(s) “comprises” and/or “comprising” specify/specifies the presence of stated components, steps, operations, and/or elements, but do/does not preclude the presence or addition of at least one other component, step, operation, and/or element.

Due to the vast amount of digital information, there are cases where it is rather difficult for a user to accurately find desired information through a search. Question answering is a technology that finds information by indexing/searching big data and identifying user question intention to obtain accurate information based on various types of information, and presents desired responses. More specifically, the question answering is a technology that, when a natural language query is input, searches a document set through a symbolic or deep learning-based document search system, and extracts from a document or generates and presents the text with the highest correct answer probability through a re-ranking model and a machine reading comprehension model (a model in which the machine receives a question and a text containing an answer to the question, and finds the correct answer within the input text) pre-trained with questions, documents, and correct answers. The question-answering technology may also include a correct answer verification technology that recognizes the part that is the basis for extracting the correct answer.

Due to the development of deep learning technology, the question-answering technology can show very high correct answer extraction performance when the correct answer is clear and when there is a document from which the correct answer can be inferred, and can learn documents without correct answers and inform that there is no correct answer when there is no correct answer. However, the existing question answering system lacks the ability to distinguish between a case where there are several documents from which the same correct answer can be inferred, and a case where there are several documents from which different correct answers can be inferred. As for an open domain-based question answering system based on Wikipedia, there are many cases where there are multiple documents from which the correct answer(s) to an input question can be inferred. For example, the correct answer to the question “Who assassinated Kim Koo?” is likely to be found in the document <Kim Koo>, but the correct answer may also be found in the document <The person who assassinated Kim Koo>. In addition, the document about <the place where Kim Koo was assassinated> may have clues from which the correct answer can be inferred.

Since the above-described example is a case of inferring one correct answer from several documents (i.e. since there are multiple documents from which the same correct answer can be inferred), it may not be a big problem. However, in the case of the question “Who is the President of the Republic of Korea in 2017?”, since there can be two correct answers instead of one, the question answering system must provide two correct answers. Further, even in the case of questions that have not yet been scientifically concluded and are subject to controversy, it is necessary to divide and present the correct answers and their bases according to assertions in multiple respects, rather than presenting only any one side of the assertions as the correct answer.

The open domain question answering system based on a large-capacity encyclopedia such as Wikipedia often receives questions with multiple answers as well as questions requiring clear answers or having only one correct answer. As in the above-described example, in the case of the question “Who is the President of the Republic of Korea in 2017?”, the paragraphs from which the correct answer can be inferred are likely to exist in documents <Park Geun-hye>, <Moon Jae-in>, and <List of Presidents of the Republic of Korea>. The conventional way is to use deep learning-based re-ranking models and machine reading comprehension models, so “Moon Jae-in” is highly likely to be inferred as the correct answer because the paragraph <Moon Jae-in was inaugurated as the 19th President of the Republic of Korea on May 10, 2017> is most similar to the question. However, the paragraph <The term of office of President Park Geun-hye of the Republic of Korea is from Feb. 25, 2013 to Mar. 10, 2017> also has a high similarity to the question, from which the second grade answer can be inferred with a probability similar to that of “Moon Jae-in”. In 2017, since there was also the acting President, indeed the issue may become more complicated. A situation like this can happen in any year when the president changes, and if you broaden your view, questions including time information have the increased probability that situations like this may occur. If only the first grade answer is used, the question answering system may suffer from a serious performance degradation, and result in the damaged reliability due to failure to deliver accurate information to users. In order for the question answering system to become reliable, it should be able to infer the existence of multiple correct answers, in addition to being able to infer a correct answer if any, and infer that if not, then there is no correct answer. In other words, the answers to the above question can be inferred as “Answer: Park Geun-hye, Basis: President's term Feb. 25, 2013-Mar. 10, 2017”, “Answer: Moon Jae-in, Basis: He was inaugurated as the 19th President of the Republic of Korea on May 10, 2017. Basis: May 10, 2017-May 9, 2022 19th President of the Republic of Korea”.

The open domain-based question answering system receives, with a high probability, a question for which only one correct answer cannot be specified. In the case of presenting a correct answer based on the existing re-ranking or machine reading probability, a situation occurs in which even though it is a correct answer, it is regarded as an incorrect answer. In addition, since the answers to the theory or situation under debate have not yet been concluded, all the answers based on every standpoint should be able to be presented as the correct answers.

The present disclosure has been proposed in view of the above-described drawbacks, and is to provide a question answering system and method capable of presenting all correct answers when there is a dispute or when there are two or more correct answers. According to an embodiment of the present disclosure, based on the fact that in the case of a correct answer to a given question, the probability of a re-ranked paragraph is high, and the probability of a correct answer text extracted from a paragraph is also high in machine reading comprehension, for correct answers with probabilities equal to or greater than a certain threshold, it is determined whether the paragraph from which the correct answer was extracted supports the corresponding correct answer or not, and the supporting paragraphs are regarded as bases for the correct answers and presented together with the correct answers. In this case, there is not only one correct answer, but several correct answers may be presented.

According to an embodiment of the present disclosure to be described below, a document search is performed with respect to a natural language query, the searched document and query token are used as input and the correct answers are inferred through re-ranking and machine reading processes, and when the probability difference between the inferred correct answers is not large, it is determined whether each of the documents supports or opposes the corresponding correct answer, and the final correct answers may be presented in the form of multiple correct answers.

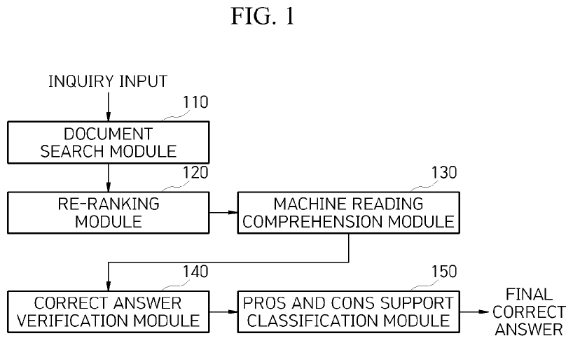

FIG. 1 shows a question answering system capable of inferring multiple correct answers according to an embodiment of the present disclosure.

The question answering system capable of inferring multiple correct answers according to an embodiment of the present disclosure includes a document search module 110, a re-ranking module 120, a machine reading comprehension module 130, a correct answer verification module 140, and a pros and cons support classification module 150.

The document search module 110 receives a query made in natural language.

The document search module 110 performs a symbolic search and a deep learning search. For the symbolic search, the result of the linguistic analysis of a natural language question is used as input. For the deep learning search, morphological analysis is performed on the question, and tokens split by the tokenizer of the deep learning model are used as input. The output of the document search module 110 includes N ranked paragraphs of the symbolic search, and M ranked paragraphs of the deep learning search, and duplicate paragraphs may be searched.

The re-ranking module 120 ranks the search paragraphs one more time using a deep learning model trained with question and correct answer and incorrect answer paragraph groups. Since the re-ranking module 120 performs re-ranking on up to N+M paragraphs (paragraphs on which the symbolic search and the deep learning search have been performed), the similarity to the question for all paragraphs is measured, which can also be used as the correct answer reliability of a question answering system.

Machine reading comprehension module 130 receives as input the re-ranked paragraphs and questions, and infers correct answers from the paragraphs. In order to improve the function/performance of the question answering system according to an embodiment of the present disclosure, the machine reading comprehension module 130 is constituted as a multi-task model capable of No answer inferring, Yes/No response inferring or the like in addition to correct answer inferring.

The correct answer verification module 140 determines whether there are multiple correct answers. The correct answer verification module 140 linearly combines the probabilities of the re-ranking of the search paragraph and the machine reading comprehension model as shown in [Equation 1] by linearly combining the probabilities of the re-ranking of the search paragraph and the machine reading comprehension module 130.

λ*re-ranking probability+(1−λ)*machine reading probability [Equation 1]

The correct answer verification module 140 determines that the question has multiple correct answers when the result of the linear combination exceeds the threshold value.

When there are multiple correct answers, the pros and cons support classification module 150 makes determination as to whether the paragraph from which the corresponding correct answer is extracted supports the corresponding correct answer or not. The pros and cons support classification module 150 determines the case where the correct answer is included in the searched paragraph and thus the correct answer is extracted in the machine reading comprehension module 130, but the answer does not actually satisfy the question, and the pros and cons support classification module 150 trains a deep learning model using training data that classifies whether the correct answer is supported or not supported using <CLS> tokens with <CLS> Question <SEP> Correct answer <SEP> Paragraph <SEP> as input.

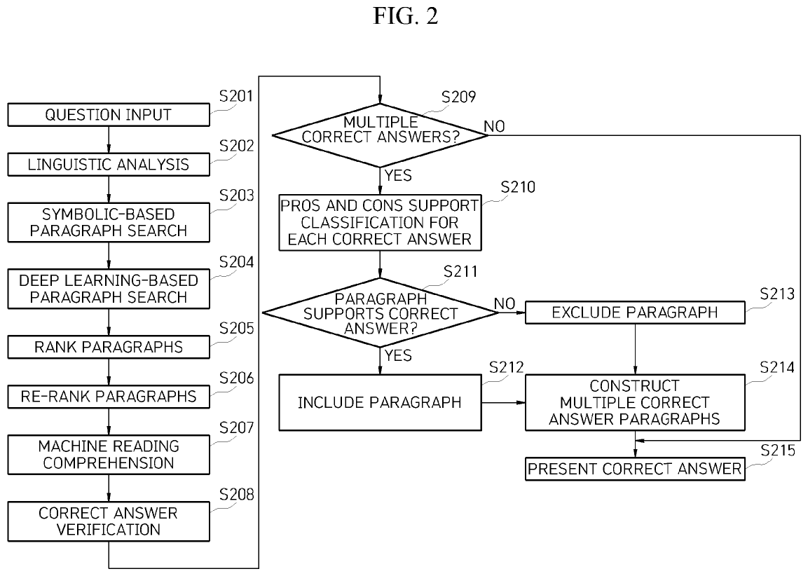

FIG. 2 shows a question answering method capable of inferring multiple correct answers according to an embodiment of the present disclosure.

When a natural language question is input in step S201, the linguistic analysis is performed on the natural language question in step S202.

In step S202, the linguistic analysis, such as, morphological analysis, named entity recognition, syntactic analysis, semantic role labeling, or cross-reference recognition, is performed on the natural language question. The linguistic analysis result is used as a feature of symbolic-based paragraph search, and the morphological analysis result is used as a feature of deep learning-based paragraph search.

In step S203, the symbolic-based paragraph search is performed. The paragraph search using a BM25-based symbolic feature is performed using the result of analyzing documents such as Wikipedia or the like.

In step S204, the paragraph search is performed through deep learning-based similarity calculation between the question and the paragraph.

In step S205, the searched paragraphs are ranked by linearly combining the symbolic-based paragraph search score and the deep learning-based paragraph search score.

In step S206, the paragraphs ranked in step S205 are re-ranked using the deep learning re-ranking model trained with the question-{correct answer paragraph, incorrect answer paragraph group}.

In step S207, the correct answer is extracted from the re-ranked paragraphs, using the deep learning model trained with question-paragraph-correct answer. Based on learning data including question-paragraph-answer and location information extracted from Wikipedia, when a question and a paragraph are given, the machine reading comprehension model extracts the text with the highest probability of being a correct answer within the paragraph. Multi-task training is performed to find the correct answer in the searched paragraph, and to enable an answer to the case where there is no correct answer (No answer) and a Yes/No answer to a question. Therefore, through classification, it is determined that the question has a correct answer, or that the question has no correct answer, or that the correct answer is Yes or No, and if there is a correct answer, the correct answer is extracted from the paragraph.

In step S208, the probability that the paragraph has a correct answer, and the probability of a correct answer are calculated for the case where there is a correct answer through performing the re-ranking and the machine reading comprehension. For the multiple-correct answer probability obtained by linearly combining the respective probabilities (λ*reranking probability+(1−λ)*machine reading probability), the λ value can be obtained through the machine learning.

In step S209, when the multiple-correct answer probability for different correct answers exceeds a specific threshold probability (e.g., 0.9), they are recognized as multiple correct answers.

In step S209, when the multiple-correct answer probability is lower than the critical probability, it is determined that they are not multiple correct answers, and in step S215, the correct answer extracted through the machine reading comprehension is presented.

In step S209, when the multiple-correct answer probability exceeds the critical probability, it is determined that they are multiple correct answers, and in step S210, it is verified whether or not the searched paragraph supports the corresponding correct answer. Through this, it is verified once more whether an error occurs in the re-ranking and the machine reading comprehension. When a specific task is verified through different deep learning models, it can be expected that the accuracy rate of the task will increase. In step S211, the deep learning classification model can be used to determine whether the searched paragraph supports the correct answer, and according to an embodiment of the present disclosure, the classification is performed using an encoder series model. The input is in the form of <CLS> question <SEP> correct answer <SEP> search paragraph <SEP> for each correct answer, and the <CLS> token including the context information of the question and paragraph is used to classify whether or not the paragraph supports the correct answer. Through this, it is possible to prevent an error in which the correct answer is extracted with a high probability because the correct answer is included in the paragraph which, however, does not support the correct answer.

When it is determined in step S211 that the paragraph does not support the correct answer, the corresponding paragraph and the correct answer are excluded in step S213. When there are still correct answers different from each other after excluding the paragraphs that do not support the correct answer, a multiple-correct answer result is presented to the user.

When it is determined in step S211 that the paragraph supports the correct answer, the paragraph is included, in step S212, by regarding that there are valid multiple correct answers, and in step S214, correct answer support paragraphs for the same correct answer are merged, and in step 215, the multiple correct answers are presented to the user.

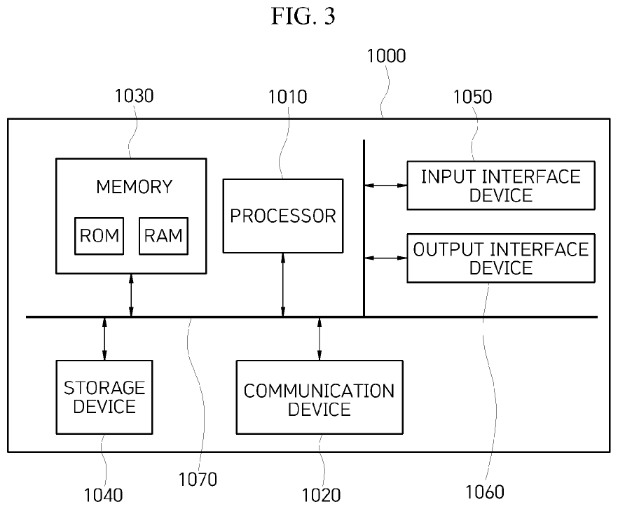

FIG. 3 is a block diagram illustrating a computer system for implementing the method according to the embodiment of the present invention.

Referring to FIG. 3, a computer system 1000 may include at least one of a processor 1010, a memory 1030, an input interface device 1050, an output interface device 1070, and a storage device 1040 that communicate through a bus 1070. The computer system 1000 may also include a communication device 1020 coupled to a network. The processor 1010 may be a central processing unit (CPU) or a semiconductor device that executes instructions stored in the memory 1030 or the storage device 1040. The memory 1030 and the storage device 1040 may include various types of volatile or non-volatile storage media. For example, the memory may include a read only memory (ROM) and a random access memory (RAM). In the embodiment of the present disclosure, the memory may be located inside or outside the processing unit, and the memory may be connected to the processing unit through various known means. The memory may be various types of volatile or non-volatile storage media, and the memory may include, for example, a ROM or a RAM.

An apparatus for predicting AI useful life based on accelerated life testing data according to an embodiment of the present invention includes an input interface device 1050 that receives accelerated life training data and actual operation testing result, a memory 1030 that stores a program for predicting life of a device by applying an adversarial deep learning model based on acceleration constraints, and a processor 1010 that executes a program, in which the processor 1010 performs the life prediction using the actual operation testing result based on the difference between intercepts calculated for each domain on the life distribution estimation line which is the accelerated life testing result.

The input interface device 1050 receives data according to the accelerated variable setting, receives data of a first domain, in which a correct life value exists, as the accelerated life training data by an accelerated life test, and receives data of a second domain for which life prediction is required as the actual operation testing result.

The processor 1010 performs life prediction using branched regression networks for each domain of data received by the input interface device 1050, and the regression network shares a slope weight parameter value in the same layer of the branched networks for each of the plurality of domains included in the first domain.

The processor 1010 performs learning by limiting a numerical range so that the intercept parameter values are listed in descending order in the same layer of the branched networks for each of the plurality of domains included in the first domain.

The processor 1010 performs adversarial learning to recognize the first domain and the second domain as one domain.

The processor 1010 readjusts the learning parameters of the second domain by confirming the linear relationship between the slope weight parameter and the difference between the intercepts.

The embodiment of the present invention may be implemented as a computer-implemented method, or as a non-transitory computer-readable medium having computer-executable instructions stored thereon. In one embodiment, when executed by the processing unit, the computer-readable instructions may perform the method according to at least one aspect of the present disclosure.

The communication device 1020 may transmit or receive a wired signal or a wireless signal.

In addition, the method according to the embodiment of the present invention may be implemented in a form of program instructions that may be executed through various computer means and may be recorded in a computer-readable recording medium.

The computer-readable recording medium may include a program instruction, a data file, a data structure or the like, alone or a combination thereof. The program instructions recorded in the computer-readable recording medium may be configured by being especially designed for the embodiment of the present invention, or may be used by being known to those skilled in the field of computer software. The computer-readable recording medium may include a hardware device configured to store and execute the program instructions. Examples of the computer-readable recording medium may include magnetic media such as a hard disk, a floppy disk, and a magnetic tape, optical media such as a compact disk read only memory (CD-ROM) or a digital versatile disk (DVD), magneto-optical media such as a floptical disk, a ROM, a RAM, a flash memory, or the like. Examples of the program instructions may include a high-level language code capable of being executed by a computer using an interpreter, or the like, as well as a machine language code made by a compiler.

According to the present invention, in predicting life of mechanical parts or electronic devices, it is possible to perform life estimation based only on accelerated life testing data without considering a separate life estimation model or life data distribution characteristics through an application of an adversarial deep learning model based on acceleration constraints.

According to the present invention, by applying an adversarial learning model, it is possible to solve the problem of different data characteristics between accelerated life testing data for deep learning model training and actual operational data for life inference in the real environment, and increase predictive validity of data having different characteristics.

According to the present invention, it is possible to easily obtain a life estimation result in an operating environment to be obtained by modifying some learning parameters of a deep learning model without mathematical consideration of acceleration conditions, use condition distribution, life-stress relationship, etc., when a life estimation model is applied.

The effects of the present invention are not limited to those mentioned above, and other effects not mentioned can be clearly understood by those skilled in the art from the following description.

Although embodiments of the present invention have been described in detail hereinabove, the scope of the present invention is not limited thereto, but may include several modifications and alterations made by those skilled in the art using a basic concept of the present invention as defined in the claims.

What is claimed is:

1. A question answering system capable of inferring multiple correct answers, the system comprising:
an input interface device configured to receive a query;
a memory for storing a program that analyzes the query and searches for a paragraph with a high probability of including a correct answer through a document search; and
a processor for executing the program,
wherein the processor extracts a correct answer using a result of the searching for a paragraph with a high probability of including a correct answer, determines whether the extracted correct answer corresponds to multiple correct answers, and provides a correct answer extraction result.

2. The question answering system capable of inferring multiple correct answers according to claim 1, wherein the processor performs a symbolic search and a deep learning search, and ranks the searched paragraphs by linearly combining a symbolic-based paragraph search score and a deep learning-based paragraph search score.

3. The question answering system capable of inferring multiple correct answers according to claim 2, wherein the processor re-ranks the ranked paragraphs using a deep learning re-ranking model.

4. The question answering system capable of inferring multiple correct answers according to claim 3, wherein the processor determines whether there are multiple correct answers using the linear combination of re-ranking probability and machine reading probability.

5. The question answering system capable of inferring multiple correct answers according to claim 1, wherein the processor uses a multi-task model capable of inferring correct answer, answering for a case where there is no correct answer, and answering in a Yes/No form.

6. The question answering system capable of inferring multiple correct answers according to claim 1, wherein the processor verifies whether the searched paragraph is a paragraph supporting the correct answer.

7. The question answering system capable of inferring multiple correct answers according to claim 6, wherein when determining that the searched paragraph does not support the correct answer, the processor excludes the corresponding correct answer and paragraph.

8. A question answering method capable of inferring multiple correct answers, the method comprising:
(a) analyzing an input query;
(b) performing a document search through a symbolic-based paragraph search and a deep learning-based paragraph search;
(c) ranking and re-ranking the searched paragraphs;
(d) extracting correct answers from the searched paragraph and determining whether there are multiple correct answers; and
(e) presenting the extracted correct answer to a user.

9. The question answering method capable of inferring multiple correct answers according to claim 8, wherein the step (a) includes performing a linguistic analysis including a morphological analysis, a named entity recognition, and a syntactic analysis.

10. The question answering method capable of inferring multiple correct answers according to claim 8, wherein the step (c) includes ranking the searched paragraphs by linearly combining a symbolic-based paragraph search score and a deep learning-based paragraph search score.

11. The question answering method capable of inferring multiple correct answers according to claim 8, wherein the step (c) includes performing the re-ranking using a deep learning re-ranking model trained with question-(correct answer paragraph, incorrect answer paragraph).

12. The question answering method capable of inferring multiple correct answers according to claim 8, wherein the step (d) includes linearly combining re-ranking probability and machine reading comprehension probability, and determining that there are multiple correct answers when the result of the linear combination exceeds a threshold value.

13. The question answering method capable of inferring multiple correct answers according to claim 8, wherein the step (e) includes determining whether the paragraph from which the correct answer is extracted through machine reading comprehension is a paragraph supporting the correct answer, and when determining that the searched paragraph does not support the correct answer, excluding the corresponding correct answer and paragraph.

14. The question answering method capable of inferring multiple correct answers according to claim 13, wherein the step (e) includes, when it is determined that the searched paragraph supports the correct answer, regarding that there are valid multiple correct answers and merging correct answer support paragraphs for a same correct answer.
